(19) United States
(12) Patent Application Publication
(10) Pub. No.: US 2010/0181120 A1
(43) Pub. Date: Jul. 22, 2010

(54) METAL RACK AND PLATFORM SCALE WITH THE METALRACK

(75) Inventor: Chih-Chiang LO, Xindian City (TW)

Correspondence Address: Muncy, Geissler, Olds & Lowe, PLLC, 4000 Legato Road, Suite 310, FAIRFAX, VA, 22033, US

(73) Assignee: Excell Precision Co., Ltd.

(21) Appl. No.: 12/355,215

(22) Filed: Jan. 16, 2009

(51) Int. Cl. G01G 21/02

(52) U.S. Cl. 177/253

(57) ABSTRACT

A metal rack and a bearing platform scale with the metal rack are both disclosed. The bearing platform scale includes a bearing base, a weight sensor and two metal racks. The bearing base forms a bearing surface on a top thereof, and defines a receiving space in a bottom thereof. The weight sensor is received in the receiving space and substantially deviates from peripheral sides of the receiving space. The metal racks correspond to the receiving space for supporting the bearing base, and are overlapped vertically and parallel to each other for accommodating the weight sensor therebetween. Each metal rack includes a first post at a side of the weight sensor, and a second post at an opposite side of the weight sensor. The first post and the second post are spaced apart from each other a distance smaller than width of the receiving space.

### BACKGROUND OF THE INVENTION

a) Field of the Invention

The present invention relates to a metal rack and a bearing platform scale with the metal rack, and particularly to a metal rack which has high strength coefficient so as to reduce manufacturing material, manufacturing cost and manufacturing time, thereby providing a competitive bearing platform scale.

b) Description of the Prior Art

An industrial bearing platform scale is mainly used to measure precise metal or other overweight objects which often weigh above several hundred kilometers. Besides a weight sensor b, a large enough platform is needed to load precise metal or other overweight objects with large volume. The platform has a structure made of metal with high strength coefficient, such as steel or iron etc, to have sufficient extension strength. The platform is distributed in such a way that the weight sensor b is surrounded by the platform and its weight extends beneath the platform, whereby the weight sensor b can bear weight on the platform.

As shown in FIG. 1, a conventional bearing platform scale comprises a bearing base a, a weight sensor b and a couple of metal racks c. The bearing base a forms a support surface a1 on a top and defines a receiving space a2 at a bottom. The weight sensor b is received in a center of the receiving space a2. The metal racks c correspond to the receiving space a2 for supporting the bearing base a, and are overlapped to accommodate the weight sensor b therebetween. Each metal rack c forms a post c1 at a side of the weight sensor b and another post c1 at another side of the weight sensor b. The two posts c1 are hollow tubes and are parallel to each other. The two posts c1 are spaced apart from each other a distance smaller than width of the receiving space a2, surrounding the weight sensor b. Each metal rack c further has a pair of support arms c2 parallel to each other and both perpendicular to the posts c1. Each support arm c2 includes at least two first welding portions c21 for welding to the posts c1. Both ends of the support arms c2 respectively extend to corners of the receiving space a2 for supporting the bearing base a.

The metal rack c encloses the weight sensor b through the two posts c1. The posts c1 support a center of the support surface a1 of the bearing base a. The support arms c2 support a peripheral of the support surface a1 of the bearing base a. Thus the bearing base a is supported totally.

As shown in FIG. 2, another conventional bearing platform scale comprises a bearing base a, a weight sensor b and a couple of metal racks c. The bearing base a forms a support surface a1 on a top and defines a receiving space a2 at a bottom. The weight sensor b is received in a center of the receiving space a2. The metal racks c correspond to the receiving space a2 for supporting the bearing base a, and are overlapped to accommodate the weight sensor b therebetween. Each metal rack c forms a post c1 at a side of the weight sensor b and another post c1 at another side of the weight sensor b. The two posts c1 are hollow tubes and are parallel to each other. The two posts c1 are spaced apart from each other a distance smaller than width of the receiving space a2 for surrounding the weight sensor b. Each metal rack c further has a pair of support arms c2 parallel to each other and both perpendicular to the posts c1. Each support arm c2 includes at least two first welding portions c21 for welding the support arms c2 to the posts c1. Both ends of each support arm c2 respectively extend to corners of the receiving space a2 for supporting the bearing base a. Each metal rack c also includes a pair of auxiliary arms c3 respectively at sides of the receiving space a2 and respectively perpendicular to the support arms c2. Each auxiliary arm c3 forms second welding portions c31 at both ends thereof for welding to the support arms c2.

The metal rack c encloses the weight sensor b through the two posts c1. The posts c1 support a center of the support surface a1 of the bearing base a. The support arms c2 support a peripheral of the support surface a1 of the bearing base a. The auxiliary arms c3 are placed on a peripheral of the receiving space a2. Thus the bearing base a is supported totally.

The bearing support scale has deficiencies in practice as follows:

1. The metal racks c support the support surface a1 from center to peripheral by the structure of the posts c1 and the support arms c2, together with the auxiliary arms c3. The metal racks c have excessively complicated structure and have to be welded with multiple length, resulting in waste of manufacturing cost and manufacturing time.

2. The metal racks c are mainly made by welding the two posts c1, the two support arms c2 and the two auxiliary arms c3 together. The structure is made with right angles, which forms a monotone structural path and increases overall length, resulting in waste of manufacturing material and manufacturing cost against market competitive.

3. The two posts c1, the two support arms c2 and the two auxiliary arms c3 of the metal racks c are jointed by the first welding portions c21 and the second welding portions c31. The overall structure is weak, and welding points are so much that increases welding materials, resulting in waste of manufacturing cost and manufacturing time.

The present invention is dedicated to overcome practical deficiencies of the conventional platform scales, and to provide an improved platform scale.

### SUMMARY OF THE INVENTION

A main object of the present invention is to provide a metal rack and a bearing platform scale with the metal rack, the metal rack having high strength coefficient so as to reduce manufacturing material, manufacturing cost and manufacturing time, thereby providing a competitive bearing platform scale.

The bearing platform scale of the present invention comprises a bearing base, a weight sensor and two metal racks. The bearing base forms a bearing surface on a top thereof, and defines a receiving space in a bottom thereof. The weight sensor is received in the receiving space and substantially deviates from peripheral sides of the receiving space. The two metal racks correspond to the receiving space for supporting the bearing base, and are overlapped vertically and parallel to each other for accommodating the weight sensor therebetween. Each metal rack includes a first post at a side of the weight sensor, and a second post at an opposite side of the weight sensor. The first post and the second post are spaced apart from each other a distance smaller than width of the receiving space. At least a first support arm extends unitarily from the first post, and at least a second support arm extends unitarily from the second post. Each of the at least a first support arm and the at least a second support arm bends to proximate a side of the receiving space.

The first support arm is integrated with the first post, and the second support arm is integrated with the second post. The first post, the second post, the first support arm and the second support arm enclose the weight sensor. The first support arm and the second support arm extend to peripheral sides of the receiving space, whereby the bearing base is supported wholly.

The bearing platform scale of the present invention comprises a bearing base, a weight sensor and two metal racks. The bearing base forms a bearing surface on a top thereof, and defines a receiving space in a bottom thereof. The weight sensor is received in the receiving space and substantially deviates from peripheral sides of the receiving space. The two metal racks correspond to the receiving space for supporting the bearing base, and are overlapped vertically and parallel to each other for accommodating the weight sensor there between. Each metal rack includes a first post at a side of the weight sensor, and a second post at an opposite side of the weight sensor. The first post and the second post are spaced apart from each other a distance smaller than width of the receiving space. At least a first support arm extends unitarily from the first post, and at least a second support arm extends unitarily from the second post. The at least a first support arm and the at least a second support arm extend substantially in directions reverse to each other and respectively extend to corners of the receiving space.

The first support arm is integrated with the first post, and the second support arm is integrated with the second post. The first post, the second post, the first support arm and the second support arm enclose the weight sensor and extend to peripheral corners of the receiving space, whereby the bearing base is supported wholly.

A bearing platform scale according to the present invention comprises a first post and a second post. The first post has at least a first distal end. At least a first support arm extends from the first distal end toward a direction different from the extension direction of the first post. The second post has at least a second distal end. At least a second support arm extends from the second distal end toward a direction different from the extension direction of the second post. The at least a first support arm and the at least a second support arm extend substantially in directions reverse to each other. A cavity is defined between the first post and the second post.

The first support arm is integrated with the first post, and the second support arm is integrated with the second post. The first support arm and the second support arm extend substantially in directions reverse to each other to form a wholly supporting structure. Moreover, a cavity is defined between the first post and the second post for enclosing the weight sensor.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is an exploded and partial view of a conventional bearing platform scale.

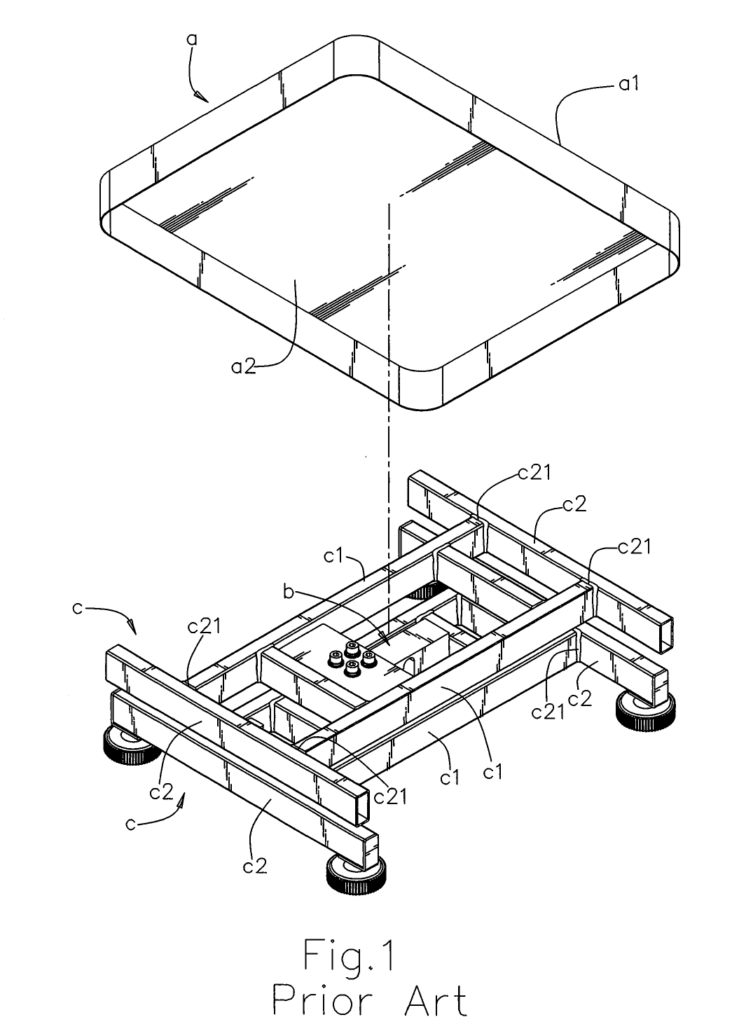

FIG. 2 is an exploded and partial view of another conventional bearing platform scale.

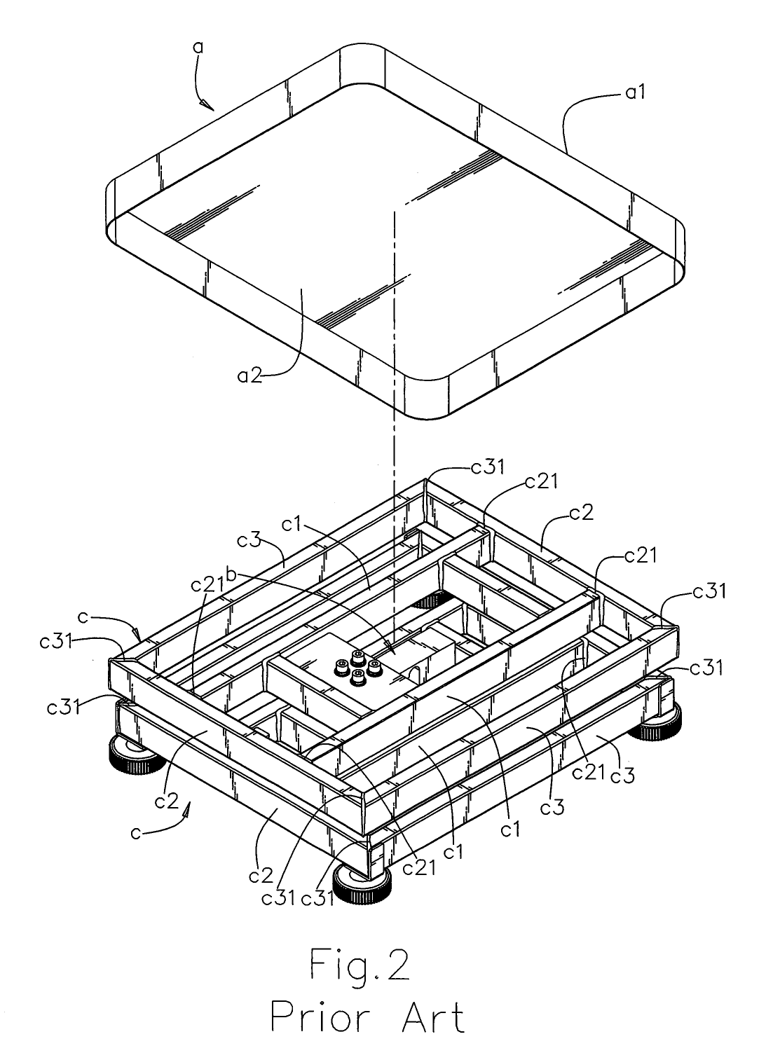

FIG. 3 is an exploded and partial view of a bearing platform scale according to the present invention.

FIG. 4 is an exemplary exploded view of the bearing platform scale according to the present invention.

FIG. 5 is a bottom view of a metal rack being jointed to a bearing base of the bearing platform scale according to one embodiment of the present invention.

FIG. 6 is a bottom view of a metal rack being jointed to the bearing base according to another embodiment of the present invention.

### DETAILED DESCRIPTION OF THE PREFERRED EMBODIMENTS

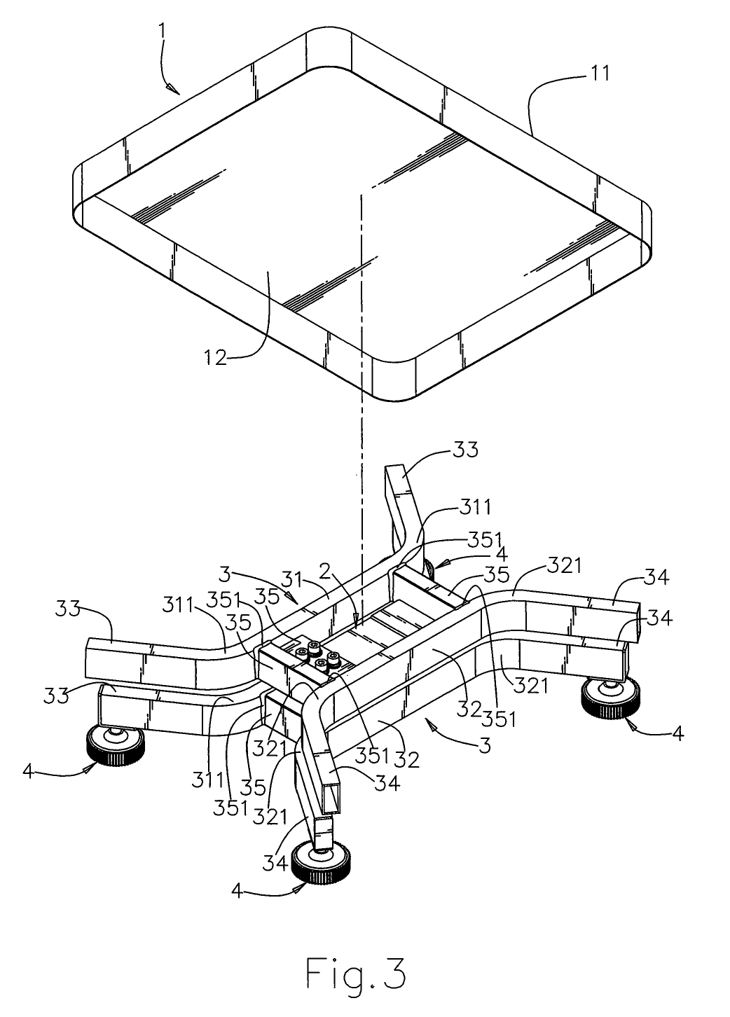

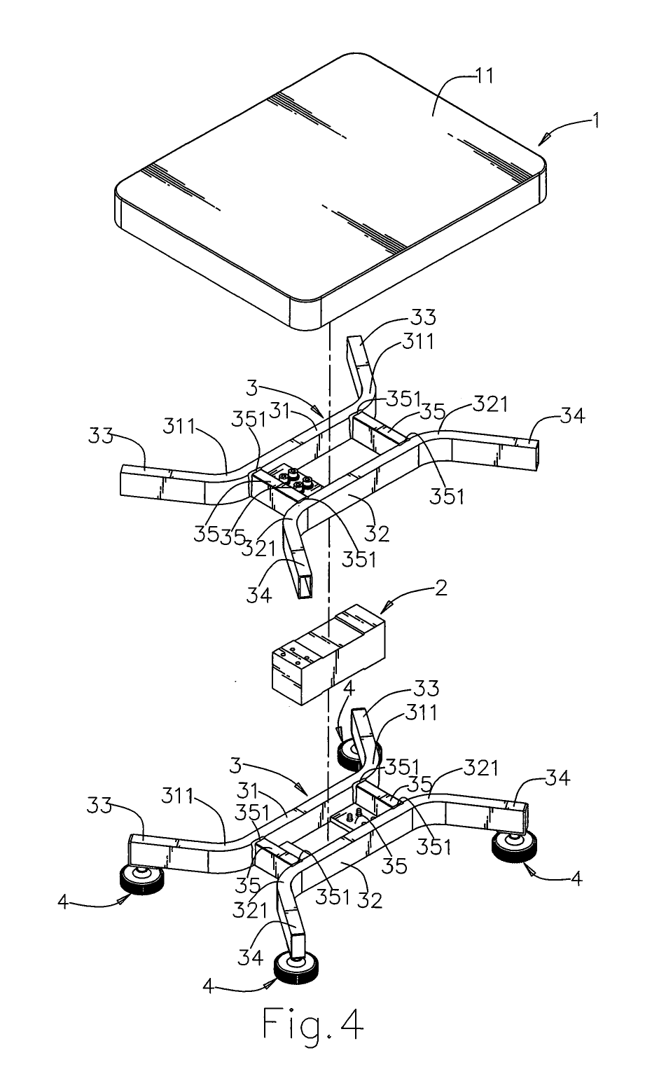

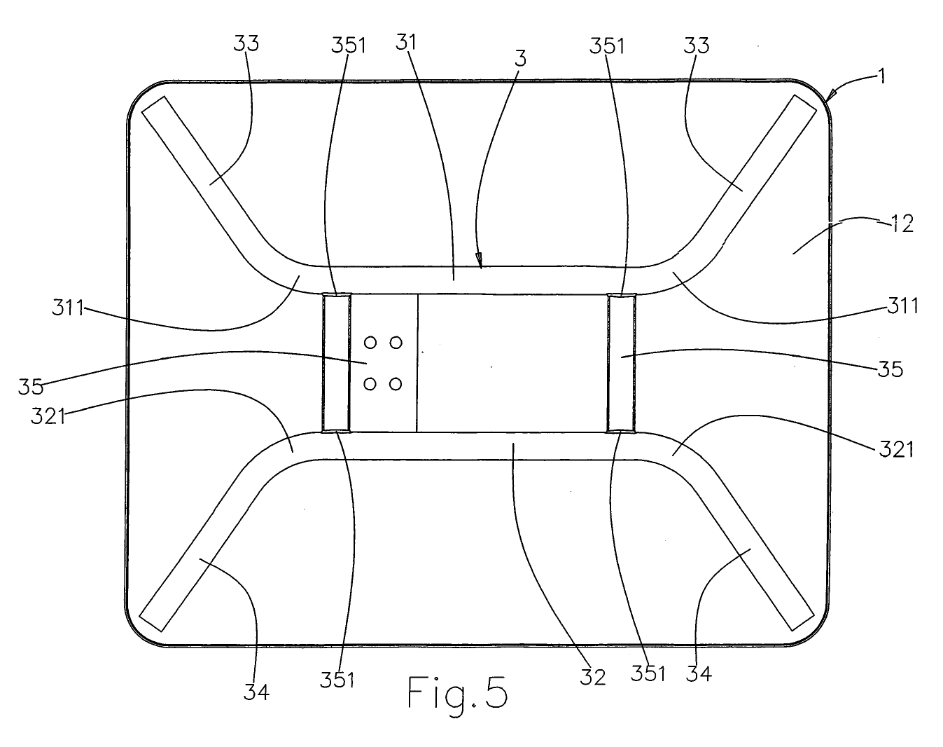

With reference to FIGS. 3 to 5, a bearing platform scale in accordance with the present invention comprises a bearing base 1, a weight sensor 2, a pair of metal racks 3 and four support pegs 4.

The bearing base 1 is polygonal and forms a bearing surface 11 on a top thereof. In one embodiment, the bearing base 1 is rectangular. The bearing base 1 has an edge bent to define a receiving space 12 in a bottom thereof.

The weight sensor 2 is received in a center of the receiving space 12, and substantially deviates from peripheral sides of the receiving space 12.

The metal racks 3 correspond to the receiving space 12 for supporting the bearing base 1, and are overlapped vertically and parallel to each other to accommodate the weight sensor 2 therebetween. The upper metal rack 3 abuts against the bearing base 1, while the lower metal rack 3 bears all the weight above. In such a way the structure is stable.

Each metal rack 3 includes a first post 31 at a side of the weight sensor 2, and a second post 32 at an opposite side of the weight sensor 2. The first post 31 and the second post 32 define a cavity (not labeled) therebetween for receiving the weight sensor 2. The first post 31 and the second post 32 are parallel to each other, but shapes of the first post 31 and the second post 32 are not restricted.

The first post 31 and the second post 32 are spaced apart from each other a distance smaller than width of the receiving space 12 for surrounding the receiving space 12. Each first post 31 forms first bending sections 311 at both ends thereof which serve as first distal ends. First support arms 33 extend unitarily from the first bending sections 311 toward a direction different from extension direction of the first posts 31. The first posts 31 and the first support arms 33 are hollow tubes. In alternative embodiments, the first posts 31 and the first support arms 33 are of other shapes, for example solid cylinder.

Each second post 32 forms second bending sections 321 at both ends thereof which serve as second distal ends. Second support arms 34 extend unitarily from the second bending sections 321 toward a direction different from extension direction of the second posts 32. The second posts 32 and the second support arms 34 may be hollow tubes, solid cylinders, or other shapes. The first support arms 33 and the second support arms 34 extend to peripheral sides of the receiving space. In some embodiments, the first support arms 33 and the second support arms 34 extend to a bottom of the bearing base 1 and exactly proximate corners of the receiving space 12. In alternative embodiments, the first support arms 33 and the second support arms 34 extend to a bottom of the bearing base 1 and only bypass corners of the receiving space 12.

At least a link bar 35 is provided between the first post 31 and the second post 32. The link bar 35 is sheet-like, and is mainly used to enclose the weight sensor 2. The bearing platform scale is assembled by welding. Each link bar 35 forms welding portions 351 on both ends thereof, and welds the first post 31 and the second post 32 together as a bridge. Therefore, the link bars 35, the first posts 31 and the second posts 32 enclose the weight sensor 2 together. When assembled, the weight sensor 2 is fixed with the link bars 35.

Four support pegs 4 are respectively provided below the first support arms 33 and the second support arms 34, and correspond to each other for supporting the bearing base 1, the weight sensor 2 and the metal racks 3.

Referring to FIGS. 3, 4, and 5, the first posts 31 and the second posts 32 of the metal racks 3 define a cavity (not labeled) therebetween for enclosing the weight sensor 2. The first support arms 33 unitarily extend and bend from the first posts 31, and the second support arms 34 unitarily extend and bend from the second posts 32. The first support arms 33 and the second support arms 34 extend substantially in directions reverse to each other and symmetric to each other. Moreover, the first support arms 33 and the second support arms 34 extend substantially from middle of the receiving space 12 to corners thereof, providing the bearing base 1 with full support to be free of slant or deformation.

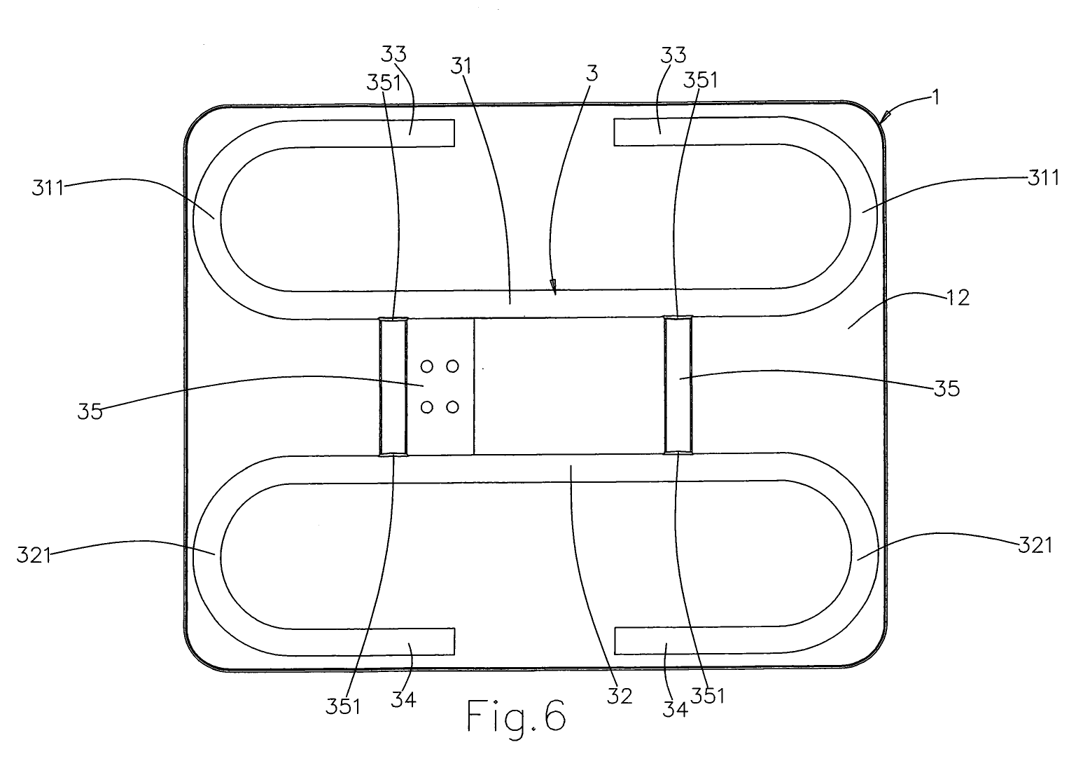

According to another embodiment of the present invention, as shown in FIG. 6, the first support arms 33 and the second support arms 34 only bypass the corners of the receiving space 12, and have ends respectively extending along sides of the receiving space 12. In other words, the first support arms 33 and the second support arms 34 have ends bending to extend along sides of the receiving space 12. Correspondingly, the first support arms 33 and the second support arms 34 have increased length in the vicinity of the sides of the receiving space 12, reinforcing sides of the bearing base 1 thereby enhancing overall strength.

The present invention, generally, has the following advantages:

1. The metal rack 3 is mainly comprised of the first post 31 with first support arms 33 extending therefrom, and the second post 32 with second support arms 34 extending therefrom. The first support arms 33 and the second support arms 34 extend substantially to corners of the receiving space 12. The overall structure does not need complex multiple-length welding, and is manufactured simply, thereby reducing manufacturing cost and manufacturing time.

2. The metal rack 3 is mainly comprised of the first post 31 with first support arms 33 extending therefrom, and the second post 32 with second support arms 34 extending therefrom. The first support arms 33 and the second support arms 34 extend from middle of the receiving space 12 to corners of the receiving space 12 in such a path that is short and flexible, and has no right angles, requiring no auxiliary arms. As a result, the present invention reduces manufacturing material and manufacturing cost, lifting its market competitive position.

The metal rack 3 is mainly comprised of the first post 31 with first support arms 33 extending therefrom, and the second post 32 with second support arms 34 extending therefrom. The structure mostly does not need welding, and correspondingly increases overall strength. The welding points decreases significantly, and therefore reduces welding materials, thereby reducing manufacturing cost and manufacturing time.

It is of course to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A bearing platform scale comprising:
a bearing base forming a bearing surface on a top thereof, and defining a receiving space in a bottom thereof;
a weight sensor being received in the receiving space and substantially deviating from peripheral sides of the receiving space;
two metal racks corresponding to the receiving space for supporting the bearing base, and being overlapped vertically and parallel to each other for accommodating the weight sensor therebetween, each metal rack including a first post at a side of the weight sensor, and a second post at an opposite side of the weight sensor, the first post and the second post being spaced apart from each other a distance smaller than width of the receiving space, at least a first support arm extending unitarily from the first post, at least a second support arm extending unitarily from the second post, each of the at least a first support arm and the at least a second support arm bending to proximate a side of the receiving space.

2. The bearing platform scale as claimed in claim 1, wherein the receiving space is defined by bending an edge of the bearing base.

3. The bearing platform scale as claimed in claim 1, wherein at least one of the metal racks abuts against the bearing base.

4. The bearing platform scale as claimed in claim 2, wherein at least one of the metal racks abuts against the bearing base.

5. The bearing platform scale as claimed in claim 1, wherein at least a link bar is provided between the first post and the second post, and welds the first post and the second post together as a bridge for enclosing the weight sensor.

6. The bearing platform scale as claimed in claim 5, wherein the at least a link bar is fixed with the weight sensor.

7. The bearing platform scale as claimed in claim 1, wherein the bearing base is polygonal, and the first support arms and the second support arms extend to a bottom of the bearing base and proximate corners of the receiving space.

8. The bearing platform scale as claimed in claim 1, wherein the first support arms respectively extend unitarily from both ends of each first post, and the second support arms respectively extend unitarily from both ends of each second post.

9. The bearing platform scale as claimed in claim 1, wherein each first support arm has a first bending section, and each second support arm has a second bending section.

10. The bearing platform scale as claimed in claim 9, wherein the first bending section extends unitarily from the first post, and the second bending section extends unitarily from the second post.

11. The bearing platform scale as claimed in claim 1, wherein the first posts, the second posts, the first support arms and the second support arms are hollow tubes.

12. The bearing platform scale as claimed in claim 1, further comprising a plurality of support pegs below the metal racks for supporting the bearing base reliably.

13. The bearing platform scale as claimed in claim 12, wherein the support pegs are respectively provided below the first support arms and the second support arms.

14. A bearing platform scale comprising:
a bearing base forming a bearing surface on a top thereof, and defining a receiving space in a bottom thereof;
a weight sensor being received in the receiving space, and substantially deviating from peripheral sides of the receiving space;
and two metal racks corresponding to the receiving space for supporting the bearing base, and being overlapped vertically and parallel to each other for accommodating the weight sensor therebetween, each metal rack including a first post at a side of the weight sensor, and a second post at an opposite side of the weight sensor, at least a first support arm extending unitarily from the first post, at least a second support arm extending unitarily from the second post, the at least a first support arm and the at least a second support arm extending substantially in directions reverse to each other and respectively extending to corners of the receiving space.

15. The bearing platform scale as claimed in claim 14, wherein the first support arms respectively extend unitarily from both ends of each first post, and the second support arms respectively extend unitarily from both ends of each second post.

16. A metal rack comprising:
a first post having at least a first distal end, at least a first support arm extending from the first distal end toward a direction different from extension direction of the first post;
a second post having at least a second distal end, at least a second support arm extending from the second distal end toward a direction different from extension direction of the second post, the at least a first support arm and the at least a second support arm extending substantially in directions reverse to each other; and
a cavity defined between the first post and the second post.

17. The metal rack as claimed in claim 16, wherein the first post has first distal ends on opposite ends thereof.

18. The metal rack as claimed in claim 16, wherein the second post has second distal ends on opposite ends thereof.

19. The metal rack scale as claimed in claim 16, wherein at least a link bar is provided in the cavity to connect the first post and the second post by welding as a bridge.

20. The metal rack as claimed in claim 19, wherein the at least a link bar is sheet-like.
